(19) United States
(12) Patent Application Publication
(10) Pub. No.: US 2010/0191610 A1
(43) Pub. Date: Jul. 29, 2010

(54) METHOD FOR AUTOMATING A FUNDRAISER TO EFFECT A PURCHASE

(75) Inventors: Edward Fields, Los Gatos, CA (US); Tom Becker, San Jose, CA (US); Matthew Kelly, San Jose, CA (US)

Correspondence Address: Stevens Law Group, 1754 Technology Drive, Suite #226, San Jose, CA, 95110, US

(73) Assignee: Hotchalk Inc., Campbell, CA (US)

(21) Appl. No.: 12/360,751

(22) Filed: Jan. 27, 2009

(51) Int. Cl. G06Q 20/00; G06Q 30/00

(52) U.S. Cl. 705/26; 705/39

(57) ABSTRACT

The invention is directed to a method for completing an online purchase via a fundraiser implemented online. This allows for an efficient manner of receiving donations to provide funds for a desired purchase, where each donation may be directly channeled to the purchase balance. Once the balance is met, the purchase may be automatically effected. For example, a computer-implemented method for effecting a purchase, configured according to the invention, provides, in electronic digital form, a user interface to initiate a fundraiser to provide funds for the purchase. Upon receiving, in electronic digital form, a user input via the user interface, a fundraiser structure, in electronic digital form, may be created based on the user input to enable receipt of a donation to pay for a portion of the purchase.

### BACKGROUND OF THE INVENTION

In the field of education, the Internet is becoming an integral part of the curriculum preparation process. Educators often search for reference materials online and integrate them into their lesson plans. These reference materials may be offered by various providers, and many of the more coveted materials may be accessed only via paid subscription. Hence, an educational entity, such as a teacher, school, or district, may wish to subscribe to a particular reference or a content package offered by a provider. However, depending on its financial situation, the entity may lack sufficient funds to effect this subscription purchase.

One solution is to perform a manual fundraiser, in which the entity requests donations from others, such as parents, community members, or other individuals, for the purpose of subscribing to the desired educational content. This traditional fundraising method may often entail administrative and logistic work requiring individuals' time and effort that may be unavailable. It is also a process that may be inefficient to implement, thus resulting in a potential delay for receiving the necessary funds.

One available fundraising option is offered by givezooks! (see http://www.givezooks.com/). This website allows a non-profit organization to create online fundraising pages, and donors may donate funds that flow to the non-profit. Another fundraising concept is presented by DonorsChoose.org (see http://www.donorschoose.org/). This website allows teachers to request donations for specific classroom needs or projects. Donors may donate via the website, and the funds are made available to purchase the requested materials.

Neither option, however, allows for the automatic payment toward a purchase, such as a content subscription. Thus, another delay is inevitable between the time that the funds are donated, and the time that the desired material or content is purchased.

Hence, it is desirable to have a solution without the above-described disadvantages. As will be seen, the invention provides such a solution in an elegant manner.

### BRIEF DESCRIPTION OF THE DRAWINGS

FIG. 1 illustrates an embodiment of the invention.

FIG. 2 illustrates another embodiment of the invention.

FIG. 3 illustrates another embodiment of the invention.

FIG. 4 illustrates another embodiment of the invention.

FIG. 5 illustrates another embodiment of the invention.

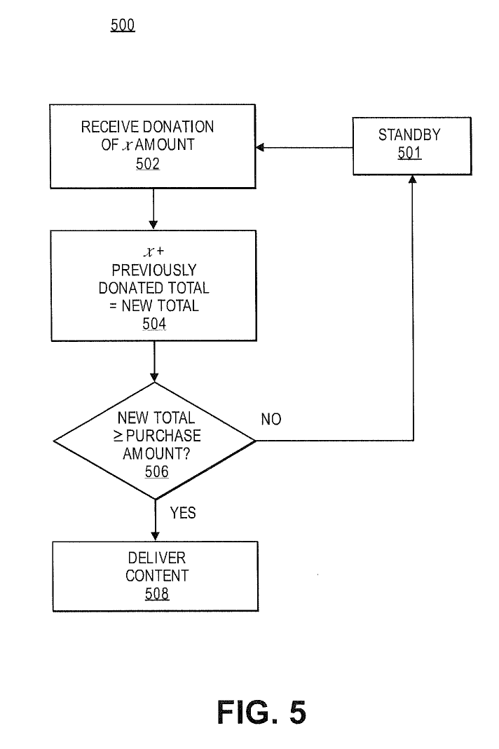

### DETAILED DESCRIPTION OF THE INVENTION

The invention is directed to a method for completing an online purchase via a fundraiser implemented online. This allows for an efficient manner of receiving donations to provide funds for a desired purchase, where each donation may be directly channeled to the purchase balance. Once the balance is met, the purchase may be automatically effected.

For example, a computer-implemented method for effecting a purchase, configured according to the invention, provides, in electronic digital form, a user interface to initiate a fundraiser to provide funds for the purchase. Upon receiving, in electronic digital form, a user input via the user interface, a fundraiser structure, in electronic digital form, may be created based on the user input to enable receipt of a donation to pay for a portion of the purchase.

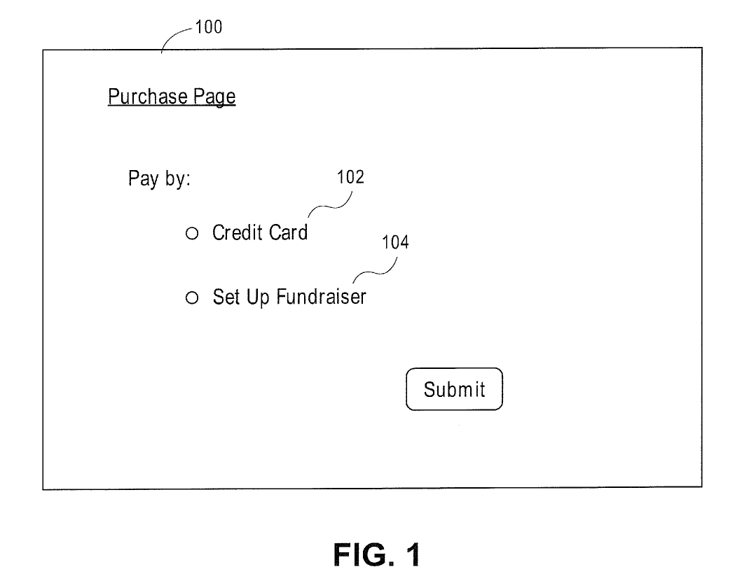

As an example, a “purchase page” 100 is shown in FIG. 1. This page 100 may appear in response to, for example, a prompt of a user indicating a purchase initiation, or an attempted access to subscription-required content to which the user is not yet subscribed. One or more standard payment options 102 may be provided. In addition, an option to set up a fundraiser 104, to receive donations to complete the purchase, may also be offered to the user.

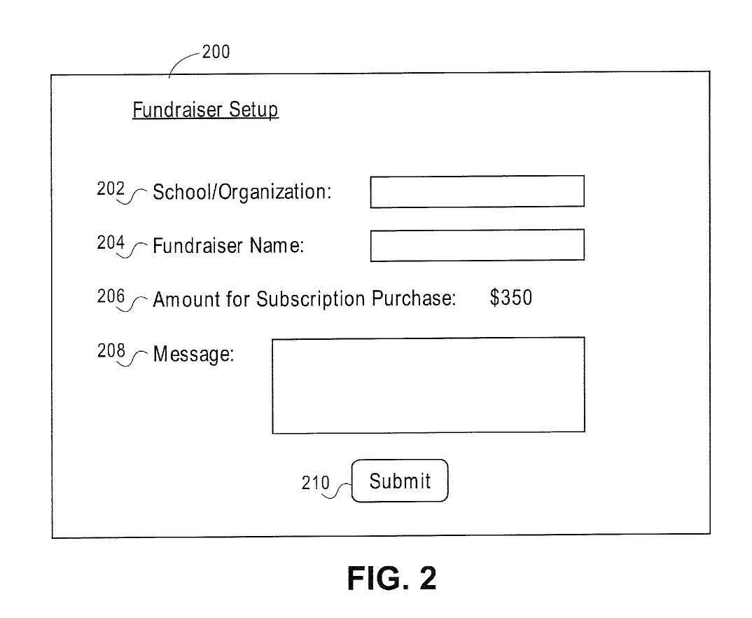

If a standard payment option 102 is selected, a standard interface for payment processing may be displayed. Should the user elect fundraiser option 104, a fundraiser setup page 200 may be displayed, an example of which is shown in FIG. 2. Various parameters 202-208 may be presented, some of which allow for the user's input, and others which may be predetermined. For example, the school or organization name 202 may be completed by the user, or may optionally be predetermined based on a prior user login input.

The amount required to complete the subscription purchase 206 may be predetermined based on a prior selection of, for example, online content. However, various options may also be provided to the user. For example, there may be an option to combine another subscription package with into this fundraiser. Also, an option may be provided to choose a particular content package including the content of interest. For example, if a particular video about liquid surface tension is the content of interest, the video may be available within a 6^{th}-grade package, and it may also be available within a science package. Another fundraiser option may allow the user to specify a requested donation amount.

Further examples of input options may include a fundraiser name 204 and a message 208. Various other options may be listed on fundraiser setup page 200, or on a page subsequent to user submission of page 200 via submit button 210. For example, a user may be offered an option to have an email automatically sent to one or more particular email addresses, informing the recipients of the fundraiser. Various options for email format and content may be included, as is known to one of ordinary skill in the art.

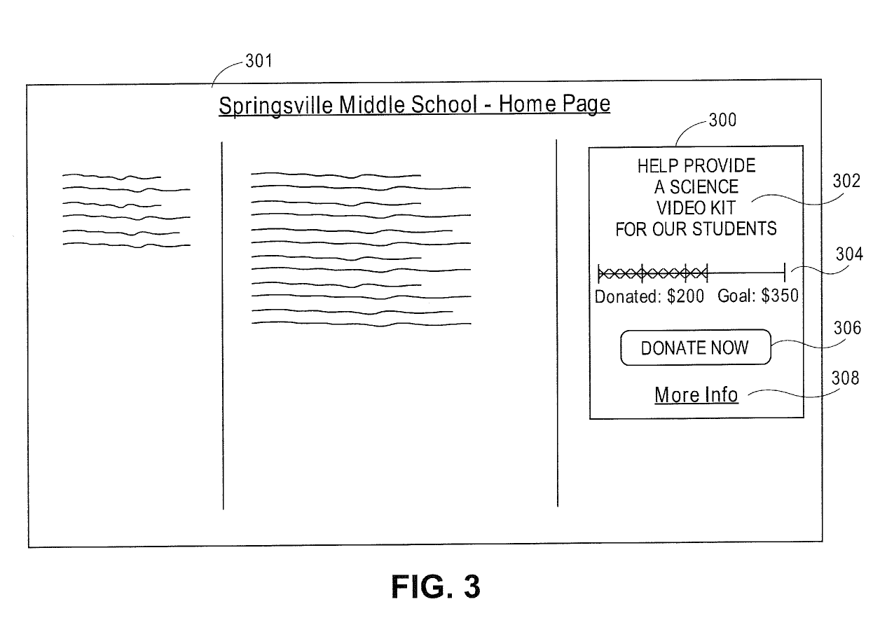

One option may include producing a fundraiser widget 300 as shown in FIG. 3. This widget may be in one of various formats, such as but not limited to an html widget posted on a school website 301 as shown, or sent in an email. Widget 300 may optionally be customized, for example, based on one or more of information provided by the user, the target content product, or according to widget options manually selected by a user. An example of widget 300 includes a headline 302 to attract the attention of webpage visitors. A goal marker 304 or “thermometer” may also be displayed to indicate the amount donated in relation to the donation goal. Goal marker 304 may be updated each time a donation is processed. A donate button 306 may direct donors to a page via which donations may be processed via credit card, Paypal, or one of various other payment options. An information link 308 may be available to provide further information about the donation process or the subscription content sought to be purchased.

Should more than one content package be desired for purchase through fundraising, a user may be offered the option to employ either an independent widget for each content package, or an integrated widget for all content packages for which fundraising is sought, or a variation thereof. Should an integrated widget be used, donors may be optionally be offered a choice of content packages to which donations should apply, and/or the option of donating without choosing a particular package.

A user may optionally be offered a method by which thank-you notes or donation receipts are sent to donors. For example, either with each donation, or upon the donation goal being met, a thank-you note or receipt may be automatically generated and emailed to each donor. Alternatively, the notes/receipts may be generated for printing onto hard copy, so that the school may send hand signed letters to their donors.

Various other options not listed herein, but known to one of ordinary skill in the art, may be included within the widget.

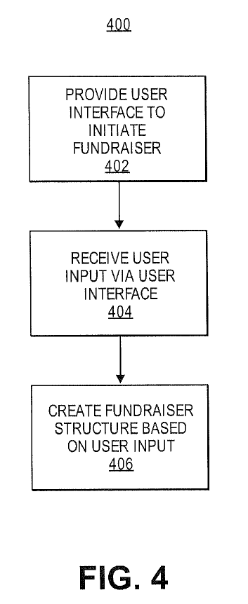

Flowchart 400 of FIG. 4 illustrates an embodiment of the invention to effect a purchase. At 402, a user interface in electronic digital form may be provided to initiate a fundraiser to provide funds for the purchase. The user interface may employ one of various display formats, and may be displayed via one of various mediums. Once user input, in electronic digital form, is received via the user interface at 404, a fundraiser structure, in electronic digital form, may be created at 406 based on the user input to enable receipt of a donation to pay for a portion of the purchase. The user input received at 404 may include, for example, a fundraiser title, information related to the fundraiser, a personal message, a text file, an image file, and/or a multimedia file.

Providing the user interface at 402 may be triggered by, for example, a user's attempt to access subscription-required online content to which the user is not subscribed. Accordingly, once it is determined that the user lacks permission to access the content, the user would be offered an option to fundraise for the purchase of a subscription. Additionally, if it is determined that the content is available for online sale, an option may be provided to obtain the content via online sale.

The fundraiser structure created at 406 may include an object, such as the widget described above in reference to FIG. 3, and may be one of, but not limited to, an application, an online user interface, and html code. This object may be customized based on one of the user input and content of the purchase, and may include an interface item to facilitate a donation process. In addition, the object may include an indication of one of a donated amount, a purchase amount, the difference between the purchase amount and the donated amount, and the percentage of the purchase amount corresponding to the donated amount. The object may be output in electronic digital form, such as via sending an email including the object, or posting the object on a website.

Once the fundraiser structure has been created, the user may publicize the fundraiser, such as via posting or transmitting the object electronically, or via other communication means. Donors may then submit donations online.

Flowchart 500 of FIG. 4 illustrates another embodiment of the invention. Upon receiving a donation at 502 via the fundraiser structure, the amount of the donation may be added at 504 to a previously donated total (or to a zero balance, at the first donation) to result in a newly donated total. Once the newly donated total meets or exceeds the amount necessary for purchase at 506, the content may be automatically delivered at 408, and the relevant individuals, such as students and/or teachers, may be given access to the content. Optionally, a message may be sent out to one or more individuals to provide notification of content accessibility. If the newly donated total falls short of the purchase amount at 506, the fundraiser structure is returned to its standby mode at 501.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

The methods include a novel approach to automating fundraising to effect purchases. Although the above embodiments are described and illustrated using examples of online educational content purchases, the scope of the invention extends to other applications where such functions are useful. Furthermore, while the foregoing description has been with reference to particular embodiments of the invention, it will be appreciated that these are only illustrative of the invention and that changes may be made to those embodiments without departing from the principles of the invention, the scope of which is defined by the appended claims and their equivalents.

What is claimed is:

1. A computer-implemented method for effecting a purchase, comprising:
providing, in electronic digital form, a user interface to initiate a fundraiser to provide funds for the purchase;
receiving, in electronic digital form, a user input via the user interface; and
creating, in electronic digital form, a fundraiser structure based on the user input to enable receipt of a donation to pay for a portion of the purchase.

2. The method of claim 1, wherein the purchase to be effected is for content, and further comprising:
receiving, in electronic digital form, a request from the user to access the content; and
determining that the user lacks permission to access the content.

3. The method of claim 2, further comprising;
determining whether the content is available for online sale; and
providing, in electronic digital form, an option to obtain the content via online sale, if the content is available for online sale.

4. The method of claim 1, wherein the user input includes one of a fundraiser title, information related to the fundraiser, a personal message, a text file, an image file, and a multimedia file.

5. The method of claim 1, wherein the fundraiser structure includes an object.

6. The method of claim 5, wherein the object is chosen from the group consisting of an application, an online user interface, and html code.

7. The method of claim 5, wherein the object is customized based on one of the user input and content of the purchase.

8. The method of claim 5, wherein the object includes an interface item to facilitate a donation process.

9. The method of claim 5, wherein the object includes an indication of one of a donated amount, a purchase amount, the difference between the purchase amount and the donated amount, and the percentage of the purchase amount corresponding to the donated amount.

10. The method of claim 5, further comprising:
outputting, in electronic digital form, the object.

11. The method of claim 10, wherein outputting the object is performed via one of sending an email including the object and posting the object on a website.

12. The method of claim 1, further comprising:
receiving a donation online;
adding an amount of the donation to a previously donated total to result in a newly donated total; and
delivering the content if the newly donated total meets or exceeds a purchase amount.
